(19) United States
(12) Patent Application Publication
(10) Pub. No.: US 2022/0308825 A1
(43) Pub. Date: Sep. 29, 2022

(54) AUTOMATIC TOGGLING OF A MUTE SETTING DURING A COMMUNICATION SESSION

(71) Applicant: Avaya Management L.P., Durham, NC (US)

(72) Inventors: Bibhuti Bhusan Tosh, Pune (IN); Piyush Bhojgude, Pune (IN); Swapnil Nagarkar, Pune (IN); Pankaj Virulkar, Pune (IN)

(21) Appl. No.: 17/212,041

(22) Filed: Mar. 25, 2021

(51) Int. Cl. G06F 3/16; H04N 7/15; G06K 9/00; H04N 7/14

(52) U.S. Cl. CPC G06F 3/165; H04N 7/15; G06K 9/00355; G06K 9/00315; H04N 7/147

(57) ABSTRACT

The technology disclosed herein enables automatic disabling of a mute setting for an endpoint during a communication session. In a particular embodiment, a method includes, during a communication session between a first endpoint operated by a first participant and a second endpoint operated by a second participant, enabling a setting to prevent audio captured by the first endpoint from being presented at the second endpoint. After enabling the setting, the method includes identifying an indication in media captured by one or more of the first endpoint and the second endpoint that the setting should be disabled. In response to identifying the indication, the method includes disabling the setting.

### TECHNICAL BACKGROUND

Modern meetings are increasingly held over remote real-time communication sessions (e.g., videoconference sessions) rather than in person. Even educational institutions have started to use live video sessions in hopes that a lack of in person instruction will not affect the academic growth of any students. While issues can arise in any remote communication session situation, as videoconferencing classes have become more prevalent, there is learning curve especially for younger children when attempting to access all the features provided by video conferencing clients. In those cases, a parent may be burdened with having help their child navigate and operate the client. For instance, a parent may need to be available to simply take their child off of mute on the videoconference when it is the child's turn to speak. The mute feature can similarly be a burden on participants that are well aware of how to operate the feature. Participants may simply forget to turn off muting before they start speaking and, similarly, may forget to turn muting back on when they are done speaking.

### SUMMARY

The technology disclosed herein enables automatic disabling of a mute setting for an endpoint during a communication session. In a particular embodiment, a method includes, during a communication session between a first endpoint operated by a first participant and a second endpoint operated by a second participant, enabling a setting to prevent audio captured by the first endpoint from being presented at the second endpoint. After enabling the setting, the method includes identifying an indication in media captured by one or more of the first endpoint and the second endpoint that the setting should be disabled. In response to identifying the indication, the method includes disabling the setting.

In some embodiments, after disabling the setting, the method includes presenting the audio captured by the first endpoint at the second endpoint.

In some embodiments, the media includes audio captured by the second endpoint and identifying the indication includes determining, from the audio captured by the second endpoint, that the second participant intends to hear audio from the first participant. In those embodiments, determining that the second participant intends to hear audio from the first participant may include one of determining that the second participant asked the first participant a question and determining that the second participant called on the first participant to speak.

In some embodiments, identifying the indication includes determining, from the audio captured by the first endpoint, that the first participant intends to be heard by the second participant.

In some embodiments, the media includes video captured by the first endpoint and identifying the indication includes determining, from the video captured by the first endpoint, that the first participant intends to be heard by the second participant. In those embodiments, determining that the first participant intends to be heard by the second participant may include determining that the first participant is facing a camera that captured the video while speaking, determining that the first participant is making a hand gesture consistent with speaking to the second participant, and/or determining that the first participant is making a facial gesture consistent with speaking to the second participant.

In some embodiments, the method includes training a machine learning algorithm to identify when a participant intends to be speaking using media from previous communication sessions. Identifying the indication in those embodiments comprises feeding the media into the machine learning algorithm, wherein output of the machine learning algorithm indicates that the setting should be disabled.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to, during a communication session between a first endpoint operated by a first participant and a second endpoint operated by a second participant, enable a setting to prevent audio captured by the first endpoint from being presented at the second endpoint. After enabling the setting, the program instructions direct the processing system to identify an indication in media captured by one or more of the first endpoint and the second endpoint that the setting should be disabled. In response to identifying the indication, the program instructions direct the processing system to disable the setting.

### BRIEF DESCRIPTION OF THE DRAWINGS

FIG. 1 illustrates an implementation for automatically disabling a mute setting during a communication session.

FIG. 2 illustrates an operation to automatically disable a mute setting during a communication session.

FIG. 3 illustrates an operational scenario for automatically disabling a mute setting during a communication session.

FIG. 4 illustrates an implementation for automatically disabling a mute setting during a communication session.

FIG. 5 illustrates an operational scenario for automatically disabling a mute setting during a communication session.

FIG. 6 illustrates an operation to automatically disable a mute setting during a communication session.

FIG. 7 illustrates an operation to automatically disable a mute setting during a communication session.

FIG. 8 illustrates a computing architecture for automatically disabling a mute setting during a communication session.

### DETAILED DESCRIPTION

The examples provided herein enable user participants at endpoints to a communication session to be automatically unmuted when it is their turn to speak. Audio and/or video captured by the endpoints is processed to determine whether a participant is intended to be heard on the communication session. For example, the participant may begin to speak and they are unmuted because it has been determined that they intend to speak to other participants on the communication session. In another example, the participant may be asked to speak (e.g., called on or asked a question) and the participant is unmuted on the communication session so that, when the participant begins to speak, the audio is properly distributed on the communication session. Automatically unmuting participants prevents, or at least reduces the likelihood, that a participant speaks while inadvertently still being on mute. Likewise, automatically unmuting participants assists those who may not know how to unmute themselves (e.g., a young child) or are otherwise incapable of doing so.

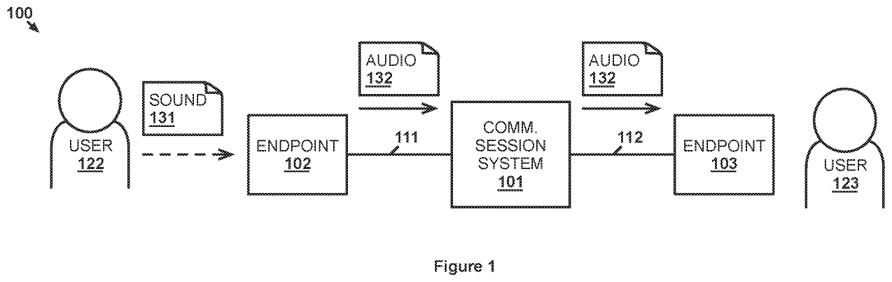

FIG. 1 illustrates implementation 100 for automatically disabling a mute setting during a communication session. Implementation 100 includes communication session system 101, endpoint 102, and endpoint 103. User 122 operates endpoint 102 and user 123 operates endpoint 103. Endpoint 102 and communication session system 101 communicate over communication link 111. Endpoint 103 and communication session system 101 communicate over communication link 112. Communication links 111-112 are shown as direct links but may include intervening systems, networks, and/or devices.

In operation, endpoint 102 and endpoint 103 may each respectively be a telephone, tablet computer, laptop computer, desktop computer, conference room system, or some other type of computing device capable of connecting to a communication session facilitated by communication session system 101. Communication session system 101 facilitates communication sessions between two or more endpoints, such as endpoint 102 and endpoint 103. In some examples, communication session system 101 may be omitted in favor of a peer-to-peer communication session between endpoint 102 and endpoint 103. A communication session may be audio only (e.g., a voice call) or may also include at least a video component (e.g., a video call). During a communication session, user 122 and user 123 are able to speak with, or to, one another by way of their respective endpoints 102 and 103 capturing their voices and transferring the voices over the communication session.

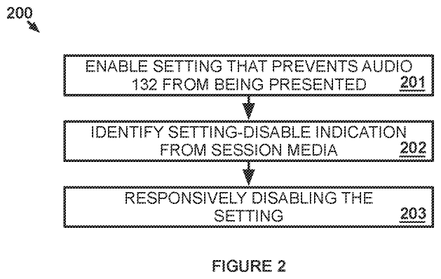

FIG. 2 illustrates operation 200 to automatically disable a mute setting during a communication session. In operation 200, a communication session is established between endpoint 102 and endpoint 103 for user 122 and user 123 to exchange real-time user communications. The exchange of real-time user communications allows user 122 and user 123 to speak to one another through their respective endpoints, which capture user 122 and el 123's voices for inclusion in the communication session. During the communication session, a setting to prevent audio captured by endpoint 102 from being presented at endpoint 103 is enabled (201). The setting is commonly called a mute setting and enabling the setting is commonly referred to as muting the microphone at the endpoint, although other terms may be used to describe the setting. The setting may be enforced locally at endpoint 102 (e.g., endpoint 102 does not transmit audio 132 or, in some cases, may not capture sound 131) or may be enforced at communication session system 101 or endpoint 103 (e.g., those systems prevent audio 132 from being played back even if audio 132 is received). The setting may be enabled via user input from user 122 directing endpoint 102 to enable the setting on the communication session, user 123 may have authority to enable the setting via user inputs into endpoint 103 directing endpoint 103 to enable the setting (e.g., user 123 may be a presenter, such as a teacher, that can mute other participants, such as their students), any of systems 101-103 may be configured to automatically enable the setting under certain conditions (e.g., when user 122 has not spoken for a threshold amount of time), or the setting may be enabled in some other manner. In some examples, the communication session may be established with the setting enabled at the outset. For instance, some conferencing platforms provide users with the ability to join a conference with their microphone muted rather than having to mute themselves after joining. When enabled, endpoint 102 may indicate to user 122 that the setting is enabled (e.g., may display a graphic representing to user 122 that the setting is enabled). A similar indicator may be presented by endpoint 103 to indicate the the setting is enabled for endpoint 102.

Enabling the setting may simply cause endpoint 102 to stop capturing sound 131 for transfer as audio 132 (i.e., a digital representation of sound 131) over the communication session. In some examples, communication session system 101 is notified of that the setting is enabled so that communication session system 101 can enable the setting on the communication session (e.g., indicate to others on the communication session that endpoint 102 has the setting enabled). In other examples, including those that rely on analysis of audio 132 to determine whether the setting should be disabled, endpoint 102 may still capture sound 131 to generate audio 132 but not transfer audio 132 generated from the capture of sound 131. In further examples, if communication session system 101, or even endpoint 103, is configured to analyze audio 132 to determine whether the setting should be disabled, then endpoint 102 may still transfer audio 132 to communication session system 101 and/or endpoint 103 so that analysis may take place. In those examples, endpoint 103 would still refrain from playing audio 132 to user 123 while the setting is still enabled.

After the setting has been enabled, an indication in media captured by one or more of endpoint 102 and endpoint 103 is identified that indicates that the setting should be disabled (202). The media from which the indication is identified may include audio 132 but audio 132 is not required in all examples. The media may include audio generated from sound captured by endpoint 103 and/or video captured by endpoint 102 and/or endpoint 103. The media may be transferred over the communication session or at least a portion of the media may be used for identifying the indication therefrom while not being transferred (e.g., video may not be enabled for the communication session even though video is still analyzed to identify the indication). The indication may comprise features such as key words/phrases identified in audio captured by endpoint 102 and/or endpoint 103 using a speech recognition algorithm, physical cues (e.g., gestures, movements, facial expressions, etc.) of user 122 and/or user 123 identified in video captured by endpoint 102 and/or endpoint 103, or some other type of indication that user 122 should be heard on the communication session—including combinations thereof.

In one example, user 122 may begin speaking, which produces sound 131 and is identified from within audio 132. In some cases, the fact that user 122 began speaking may be enough to constitute an indication that the setting should be disables while, in other cases, additional factors are considered. For instance, keywords (e.g., user 123's name, words related to a current topic of discussion, words commonly used to interject, etc.) may be identified from which the speech that confirm user 122 is speaking to those on the communication session (i.e., user 123 in this case) rather than to someone else. Alternatively (or additionally), video captured of user 122 may be analyzed to determine that user 122 is looking at endpoint 102 or is otherwise looking in a direction that indicates user 122 is speaking to those on the communication session. When the other factor(s) correlate to user 122 speaking to those on the communication session, then the indication that the setting should be disabled is considered to be identified.

In another example, user 123 may ask a question that is identified from audio captured from sound at endpoint 103. The question may be determined to be directed at user 122 based on analysis of the audio (e.g., user 123 may explicitly say user 122's name). In some cases, the question alone may constitute the indication that the setting should be disabled so that user 122 can answer but, as above, other factors may be considered. For instance, it may first be determined audio 132 that user 122 has begun speaking after being asked the question and/or video captured of user 122 may analyzed in a manner similar to that described above to indicate that user 122 is speaking to others on the communication session.

Artificial Intelligence (AI) may also be used to identify the indication that the setting should be disabled. The AI may be a machine learning algorithm that is trained using previous communication sessions to identify indicators that would indicate when user participants during those previous communication sessions were intending to be heard. That is, the algorithm analyzes audio and/or video from the communication sessions to identify factors mentioned above (e.g., keywords/phrases, gestures, movements, etc.) to determine indicators that a participant is going to speak on the communication session. In some cases, the algorithm may be tailored to a particular user(s) if enough previous communication sessions for that user are available for training. For example, certain user-specific factors (e.g., physical cues and/or keywords/phrases) may be identified for one user that are different than those for another. The algorithm may then be able to identify indicators based on those user-specific factors rather than more generic factors.

In response to identifying the indication above, the setting is disabled (203). Endpoint 102 may then notify user 122 that the setting is disabled (e.g., through a display graphic indicating that the setting is not enabled) and endpoint 103 may similarly notify user 123. If endpoint 102 enforces the setting locally and endpoint 102 itself identified the indication, then endpoint 102 may disable the setting locally and, if necessary, may notify communication session system 101 that the setting is disabled so that communication session system 101 can indicate that the setting is disabled to others on the communication session. Alternatively, if communication session system 101 or endpoint 103 identified the indication, then communication session system 101 or endpoint 103 may notify endpoint 102 to instruct endpoint 102 to disable the setting. If the setting is not enforced locally and endpoint 102 itself identified the indication, then endpoint 102 may notify communication session system 101 and/or endpoint 103 with an instruction that the setting be disabled. Alternatively, if communication session system 101 or endpoint 103 identified the indication, the communication session system 101 or endpoint 103 may disable the setting and notify endpoint 102 that the setting is now disable. Other scenarios may also exist for disabling the setting depending on how the setting is enforced and what system identifies the indication that the setting should be disabled.

Advantageously, rather than user 122 or user 123 manually disabling the setting, the setting is automatically disabled upon identifying the indication in the media. Situations where participants forget to disable the setting manually before speaking are reduced and, potentially, even eliminated. Moreover, a participant, such as a young child, does not need to know how to manually disable the setting when the setting can be automatically disabled.

In some examples, when user 122 is done speaking, the setting may be automatically re-enabled based on an indication in the media. For example, a threshold amount of time since user 122 last spoke may trigger the setting to be re-enabled. Alternatively, the AI algorithm used to identify when the setting should be disabled (or an independent machine learning AI algorithm) may be trained to recognize when the setting can be re-enabled. That is, the algorithm may be trained by analyzing audio and/or video from previous communication sessions to identify factors, such as keywords/phrases, gestures, movements, etc., to determine indicators that a participant not going to speak for the foreseeable future or has diverted their attention from the communication session (e.g., is speaking to someone else in the room with them or is focusing on work outside of the communication session). The AI would then trigger the enabling of the setting when it recognizes a factor, or a combination of the factors, that the AI recognizes as indicating the setting should be enabled.

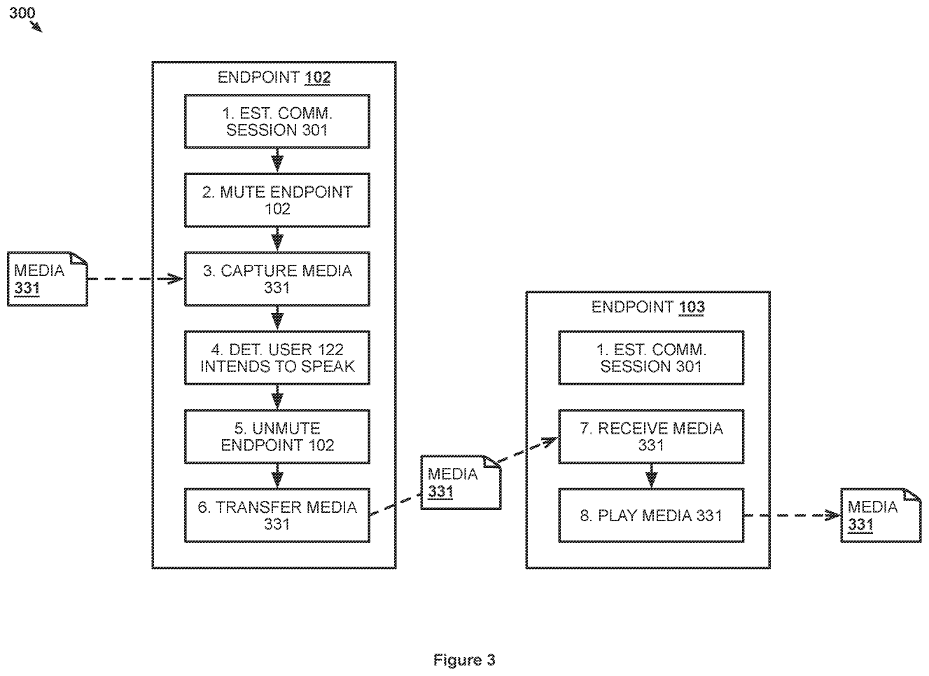

FIG. 3 illustrates operational scenario 300 for automatically disabling a mute setting during a communication session. Operational scenario 300 is an example where endpoint 102 identifies the indicator that the setting should be disabled and enforces the setting locally. At step 1, communication session 301 is established between endpoint 102 and endpoint 103. The communication session is for exchanging real-time voice communications and may also include a video component. Other types of communications, such as text chat, may also be supported in other examples. Audio captured by endpoint 102 is muted on the communication session at step 2, which constitutes the setting from operation 200 being enabled. Audio portions of media 331 that endpoint 102 captures at step 3 while endpoint 102 is muted are not transferred to endpoint 103. If video is included in media 331 and the communication session is a video communication session, then the video portion of media 331 may continue to be transferred for presentation at endpoint 103.

From media 331, endpoint 102 determines, at step 4, that user 122 intends to speak on the communication session, which is an indication that endpoint 102 should be unmuted on the communication session. For example, endpoint 102 may recognize from video in media 331 that user 122 has positioned themselves towards endpoint 102 and is making facial gestures indicating the user 122 is about to speak. In some cases, user 122 may actually begin speaking before endpoint 102 determines that they intend that speech to be included on the communication session (e.g., endpoint 102 may wait until keywords/phrases are recognized) rather than speaking for some other reason (e.g., to someone in the same room as user 122). After determining that user 122 intends to speak on the communication session, endpoint 102 automatically unmutes itself on the communication session at step 5 and begins to transfer media 331 to endpoint 103 at step 6. Endpoint 103 receives the transferred media 331 at step 7 and plays media 331 to user 123 at step 7. While not shown, media 331 may be transferred through communication session system 101 rather than directly to endpoint 103.

The portions of media 331 transferred may only be media that was captured after endpoint 102 unmuted itself and anything said while still muted would not be transferred. Alternatively, if a portion of the audio in media 331, which was captured prior to unmuting, included speech used by endpoint 102 when determining to unmute (e.g., included keywords/phrases), then endpoint 102 may include that portion when it begins to transfer media 331. In those situations, since the communication session is supposed to facilitate real time communications, at least that audio portion of media 331 may be sped up when played at endpoint 103 so that playback returns to real time as soon as possible while still being comprehendible by user 123 (e.g., may play back at 1.5 times normal speed). The playback speed may be increased due to actions taken by endpoint 103 to increase the speed or endpoint 102 may encode media 331 with the speed increase such that endpoint 103 plays media 331 as it normally would otherwise.

Should media 331 later indicate to endpoint 102 that user 122 is no longer speaking on the communication session, then endpoint 102 may then automatically mute itself on the communication session. For example, if no speech is detected in media 331 for a threshold amount of time, then endpoint 102 may re-enable the muting of endpoint 102. In another example, video in media 331 may be analyzed to determine that, even in situations where user 122 is still speaking, user 122 is speaking to someone in person and not on the communication session. Likewise, an AI may be used to determine when user 122 should be muted, as mentioned above. Endpoint 102 may mute itself automatically at step 2 above in a similar manner.

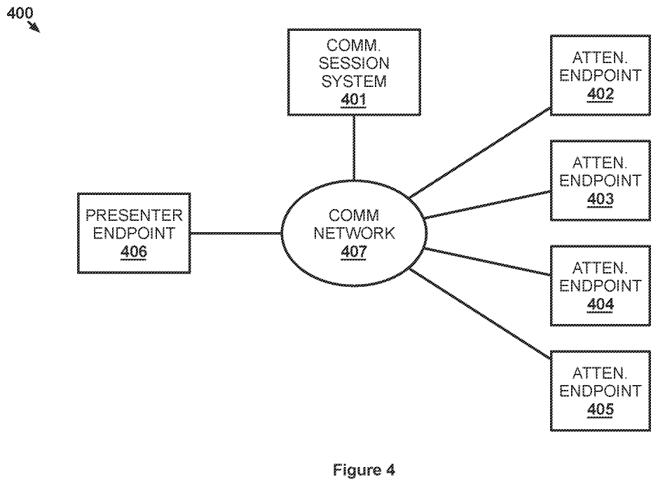

FIG. 4 illustrates implementation 400 for automatically disabling a mute setting during a communication session. Implementation 400 includes communication session system 401, endpoints 402-406, and communication network 407. Communication network 407 includes one or more local area networks and/or wide area computing networks, including the Internet, over which communication session system 401 and endpoints 402-406. Endpoints 402-406 may each comprise a telephone, laptop computer, desktop workstation, tablet computer, conference room system, or some other type of user operable computing device. Communication session system 401 may be an audio/video conferencing server, a packet telecommunications server, a web-based presentation server, or some other type of computing system that facilitates user communication sessions between endpoints. Endpoints 402-406 may each execute a client application that enables endpoints 402-406 to connect to communication sessions facilitated by communication session system 401 and provide features associated therewith, such as the automated mute feature described herein.

In this example, presenter endpoint 406 is operated by a user who is a presenting participant on a communication session facilitated by communication session system 401. The presenting participant may be an instructor/teacher, may be a moderator of the communication session, a designated presenter (e.g., may be sharing their screen or otherwise presenting information), may simply be the current speaker, or may be otherwise considered to be presenting at present during the communication session. As such, in some cases, the presenter endpoint may change depending on who is currently speaking (or who is the designated presenter) on the communication session while, in other cases, the presenter endpoint may be static throughout the communication session. Attendee endpoints 402-405 are operated by attendee users who watching and listening to what the presenter is presenting on the communication session. The attendee users may be students of the presenting user, may be participants that are not currently designated as the presenter, may simply not be the current speakers, or may be some other type of non-presenting participants.

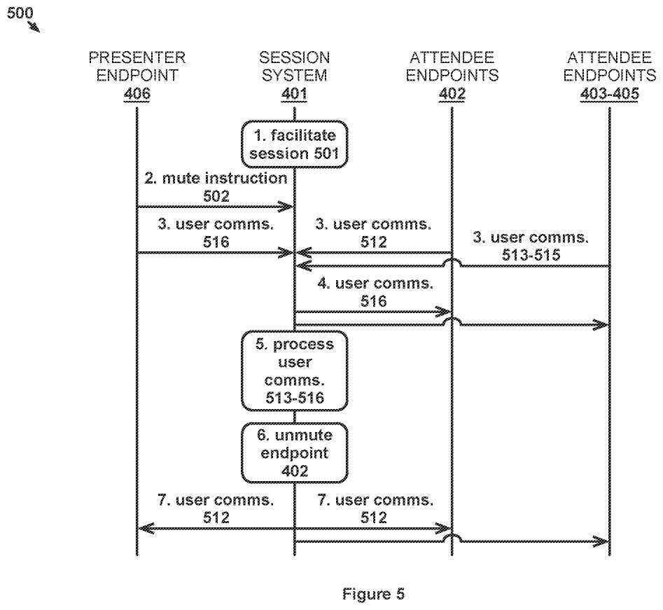

FIG. 5 illustrates operational scenario 500 for automatically disabling a mute setting during a communication session. During operational scenario 500, communication session system 401 begins facilitating communication session 501, at step 1, between endpoints 402-406. In this example, communication session 501 is a video communication session. After communication session 501 is established, presenter endpoint 406 transfers mute instruction 502 to communication session system 401 at step 2. The presenting user at presenter endpoint 406 has the authority to mute other endpoints on communication session 501 and directs presenter endpoint 406 to send mute instruction 502 that instructs communication session system 401 to mute attendee endpoints 402-405. In one example where the presenting user is a teacher and the attendee users are students, muting the students' endpoints prevents the students from talking over each other and/or the teacher.

Even though attendee endpoints 402-405 are all muted by communication session system 401 in response to mute instruction 502, user communications 512-516 from each respective one of endpoints 402-406 are still received by communication session system 401, at step 3, over communication session 501. The user communications include audio and video real-time media captured by attendee endpoints 402-405. However, since attendee endpoints 402-405 are all muted, user communications 512-515 are not transferred to the other endpoints on communication session 501 for presentation. Instead, only user communications 516 from presenter endpoint 406, which is not muted, are transferred to attendee endpoints 402-405, at step 4, for presentation to their respective users.

While user communications 512-515 are not transferred, communication session system 401 still uses user communications 512-515 along with user communications 516 when determining whether any of attendee endpoints 402-405 should be unmuted. As such, communication session system 401 processes user communications 512-516 in real-time, at step 5, to determine whether anything therein indicates that one or more of attendee endpoints 402-405 should be unmuted. In this example, communication session system 401 determines that attendee endpoint 402 should be unmuted. Most likely, communication session system 401 used user communications 516 and/or user communications 512 to determine that attendee endpoint 402 should be unmuted, although, user communications 513-515 may also factor into the decision (e.g., user communications 513-515 may not include speech, which indicates that the users of attendee endpoints 403-405 are not talking and do not need to be heard). As discussed above, audio and/or video from within user communications 516 and user communications 512 may be used to determine that attendee endpoint 402 should be unmuted. For example, audio in user communications 516 may include speech from the presenting user directing the user of attendee endpoint 402 to speak (e.g., by asking the user a question). Similarly, the speech may invite responses from any of the users operating attendee endpoints 402-405 and communication session system 401 may recognize from audio and/or video in user communications 512 that the user of attendee endpoint 402 intends to speak in response to the presenting user's invite. For instance, video in user communications 512 may recognize that the user of attendee endpoint 402 begins to sit up in their chair and makes a facial expression indicating that they are about to speak. In another example, user communications 512 may include audio of the user speaking a phrase, such as “I have something to say,” which indicates to communication session system 401 that attendee endpoint 402 should be unmuted.

In response to determining that attendee endpoint 402 should be unmuted, communication session system 401 actually unmutes attendee endpoint 402 at step 6. In some examples, unmuting attendee endpoint 402 includes notifying endpoints 402-406 that attendee endpoint 402 is now unmuted (e.g., so that an indicator at each of endpoints 402-406 signifies that attendee endpoint 402 is not muted). Since communication session system 401 is already receiving user communications 512, communication session system 401 simply begins transmitting user communications 512 over communication session 501 to endpoints 403-406. As discussed above, user communications 512 may only include portions that are received after communication session system 401 has unmuted attendee endpoint 402 or may also include portions of user communications 512 that indicated attendee endpoint 402 should be unmuted.

Should communication session system 401 determine that the attendee at attendee endpoint 402 should be muted, communication session system 401 may then mute user communications 512 from attendee endpoint 402 accordingly. Only user communications 512 may be used to make the muting determination or user communications from other endpoints may be considered as well. For example, the presenter may indicate in user communications 516 that the attendee at attendee endpoint 402 is done speaking (e.g., by saying “that's enough for now” or by selecting another attendee to speak).

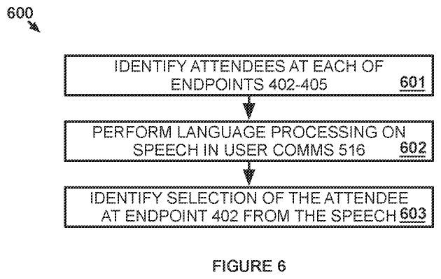

FIG. 6 illustrates operation 600 to automatically disable a mute setting during a communication session. Operation 600 is an example of how communication session system 401 may determine that the attendee at endpoint 402 should be unmuted on communication session 501 in step 5 of operational scenario 500. Communication session system 401 identifies the attendees at each of attendee endpoints 402-405 (601). The attendees may be identified from their respective logins for access to communication session 501 (e.g., based on an attendee profile associated with the username provided to log into a communication session client application), from identification information provided by the attendees themselves (e.g., the attendees may enter their names into attendee endpoints 402-405), from identification information provided by the presenter at endpoint 406, from analyzing audio and/or video captured of each attendee (e.g., comparing it to known audio or image samples of potential attendees), or may be determined in some other manner—including combinations thereof. While discussed with respect to step 5 of operational scenario 500, the attendees may be determined earlier on in operational scenario 500, such as upon establishment of communication session 501.

Communication session system 401 performs natural language processing on speech in user communications 516 to determine whether any of the attendees identified above are mentioned therein (602). More specifically, the natural language processing determines whether any of the attendees is mentioned in a context that would warrant the attending beginning to speak on communication session 501. For example, from user communications 516, communication session system 401 may identify an attendee that has been asked a question, has been called upon, or has otherwise been selected by the presenter for speaking on communication session 501. In this example, communication session system 401 identifies the attendee at attendee endpoint 402 as having been selected by the presenter in user communications 516 (603). Attendee endpoint 402 is, therefore, the endpoint of attendee endpoints 402-405 that will be unmuted at step 6 of operational scenario 500.

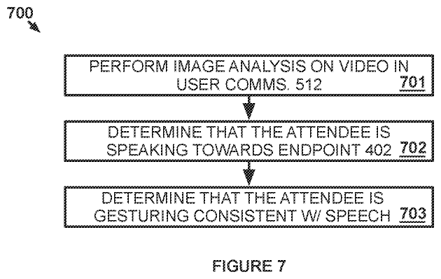

FIG. 7 illustrates operation 700 to automatically disable a mute setting during a communication session. Operation 700 is another example of how communication session system 401 may determine that the attendee at endpoint 402 should be unmuted on communication session 501 in step 5 of operational scenario 500. In operation 700, communication session system 401 performs image analysis on video in user communications 512 (701). Communication session system 401 may likewise perform image analysis on video in user communications 513-515 but only user communications 512 are discussed in this example. The image analysis determines whether the attendee at attendee endpoint 402 is moving, gesturing, making expressions, etc., in a manner consistent with intending to speak on communication session 501. In this example, communication session system 401 determines that the attendee is speaking towards attendee endpoint 402 (702). For instance, communication session system 401 may determine that the attendee is facing a camera of attendee endpoint 402 that captured the video and may determine that the attendee's mouth is moving in a manner consistent with speaking. In some cases, audio from user communications 512 may be referenced to confirm that the attendee is speaking towards attendee endpoint 402. Communication session system 401 also determines that the attendee is gesturing in manner constant with speaking to attendees on the communication session (703). For example, the attendee may be moving their hands in a manner consistent with someone speaking. The above determinations indicate to communication session system 401 that attendee endpoint 402 should be unmuted so that the attendee thereat can be heard on communication session 501. In other examples, other criteria may be used to determine that attendee endpoint 402 should be unmuted. For instance, another example may require only that the attendee is speaking towards their endpoint rather than require the attendee also be gesturing, as is the case in operation 700.

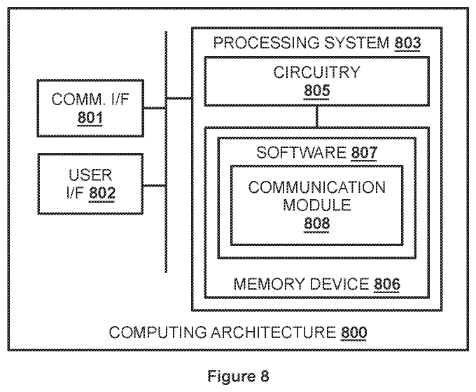

FIG. 8 illustrates computing architecture 800 for automatically disabling a mute setting during a communication session. Computing architecture 800 is an example computing architecture for communication session systems 101/401 and endpoints 102, 103, and 402-406, although systems 101-103 and 401-406 may use alternative configurations. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a storage medium of memory device 806 be considered a propagated signal. Operating software 807 comprises computer programs, firmware, or some other form of machine-readable processing instructions. Operating software 807 includes communication module 808. Operating software 807 may further include an operating system, utilities, drivers, network interfaces, applications, or some other type of software. When executed by processing circuitry 805, operating software 807 directs processing system 803 to operate computing architecture 800 as described herein.

In particular, during a communication session between a first endpoint operated by a first participant and a second endpoint operated by a second participant (either of which may use computing architecture 800), communication module 808 directs processing system 803 to enable a setting to prevent audio captured by the first endpoint from being presented at the second endpoint. After enabling the setting, communication module 808 directs processing system 803 to identify an indication in media captured by one or more of the first endpoint and the second endpoint that the setting should be disabled. In response to identifying the indication, communication module 808 directs processing system 803 to, disable the setting.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
during a communication session between a first endpoint operated by a first participant and a second endpoint operated by a second participant:
enabling a setting to prevent audio captured by the first endpoint from being presented at the second endpoint;
after enabling the setting, identifying an indication in media captured by one or more of the first endpoint and the second endpoint that the setting should be disabled, wherein identifying the indication includes determining, from a portion of the media captured by the first endpoint, that the first participant intends to be heard by the second participant; and
in response to identifying the indication, disabling the setting.

2. The method of claim 1, comprising:
after disabling the setting, presenting the audio captured by the first endpoint at the second endpoint.

3. The method of claim 1, wherein the media includes audio captured by the second endpoint, and wherein identifying the indication comprises:
determining, from the audio captured by the second endpoint, that the second participant intends to hear audio from the first participant.

4. The method of claim 3, wherein determining that the second participant intends to hear audio from the first participant comprises one of:
determining that the second participant asked the first participant a question; and
determining that the second participant called on the first participant to speak.

5. The method of claim 1, wherein identifying the indication comprises:
determining, from the audio captured by the first endpoint, that the first participant intends to be heard by the second participant.

6. The method of claim 1, wherein the media includes video captured by the first endpoint, and wherein identifying the indication comprises:
determining, from the video captured by the first endpoint, that the first participant intends to be heard by the second participant.

7. The method of claim 6, wherein determining that the first participant intends to be heard by the second participant comprises:
determining that the first participant is facing a camera that captured the video while speaking.

8. The method of claim 6, wherein determining that the first participant intends to be heard by the second participant comprises:
determining that the first participant is making a hand gesture consistent with speaking to the second participant.

9. The method of claim 6, wherein determining that the first participant intends to be heard by the second participant comprises:
determining that the first participant is making a facial gesture consistent with speaking to the second participant.

10. The method of claim 1, comprising:
training a machine learning algorithm to identify when a participant intends to be speaking using media from previous communication sessions; and
wherein identifying the indication comprises feeding the media into the machine learning algorithm, wherein output of the machine learning algorithm indicates that the setting should be disabled.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
during a communication session between a first endpoint operated by a first participant and a second endpoint operated by a second participant:
enable a setting to prevent audio captured by the first endpoint from being presented at the second endpoint;
after enabling the setting, identify an indication in media captured by one or more of the first endpoint and the second endpoint that the setting should be disabled, wherein identification of the indication includes a determination, from a portion of the media captured by the first endpoint, that the first participant intends to be heard by the second participant; and
in response to identifying the indication, disable the setting.

12. The apparatus of claim 11, wherein the program instructions direct the processing system to:
after disabling the setting, present the audio captured by the first endpoint at the second endpoint.

13. The apparatus of claim 11, wherein the media includes audio captured by the second endpoint, and wherein to identify the indication, the program instructions direct the processing system to:
determine, from the audio captured by the second endpoint, that the second participant intends to hear audio from the first participant.

14. The apparatus of claim 13, wherein to determine that the second participant intends to hear audio from the first participant, the program instructions direct the processing system to either:
determine that the second participant asked the first participant a question; or
determine that the second participant called on the first participant to speak.

15. The apparatus of claim 11, wherein to identify the indication, the program instructions direct the processing system to:
determine, from the audio captured by the first endpoint, that the first participant intends to be heard by the second participant.

16. The apparatus of claim 11, wherein the media includes video captured by the first endpoint, and wherein to identify the indication, the program instructions direct the processing system to:
determine, from the video captured by the first endpoint, that the first participant intends to be heard by the second participant.

17. The apparatus of claim 16, wherein to determine that the first participant intends to be heard by the second participant, the program instructions direct the processing system to:
determine that the first participant is facing a camera that captured the video while speaking.

18. The apparatus of claim 16, wherein to determine that the first participant intends to be heard by the second participant, the program instructions direct the processing system to:
determining that the first participant is making a hand gesture consistent with speaking to the second participant.

19. The apparatus of claim 11, wherein the program instructions direct the processing system to:
train a machine learning algorithm to identify when a participant intends to be speaking using media from previous communication sessions; and
wherein to identify the indication the program instructions direct the processing system to feed the media into the machine learning algorithm, wherein output of the machine learning algorithm indicates that the setting should be disabled.

20. One or more computer readable storage media having program instructions stored thereon that, when read and executed by a processing system, direct the processing system to:
during a communication session between a first endpoint operated by a first participant and a second endpoint operated by a second participant:
enable a setting to prevent audio captured by the first endpoint from being presented at the second endpoint;
after enabling the setting, identify an indication in media captured by one or more of the first endpoint and the second endpoint that the setting should be disabled, wherein identification of the indication includes a determination, from a portion of the media captured by the first endpoint, that the first participant intends to be heard by the second participant; and
in response to identifying the indication, disable the setting.
